(19) United States
(12) Patent Application Publication
(10) Pub. No.: US 2005/0204190 A1
(43) Pub. Date: Sep. 15, 2005

(54) Apparatus, system and method for transitioning networked computing devices to a lower power state

(75) Inventors: Daryl Carvis Cromer, Apex, NC (US); Howard Jeffrey Locker, Cary, NC (US); Randall Scott Springfield, Chapel Hill, NC (US)

Correspondence Address: KUNZLER & ASSOCIATES, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 10/748,087

(22) Filed: Dec. 30, 2003

(51) Int. Cl. G06F 11/00

(52) U.S. Cl. 714/14

(57) ABSTRACT

An apparatus, a system, and a method are provided for transitioning networked computing devices to a lower power state. The apparatus, system, and method include an interface module configured to receive a power saving command from a remote site on a network. A determination module is provided to determine whether the client is in a selected state whereby it can comply with the power savings command. A power saving module is provided to execute a selected power saving scheme responsive to a determination that the client is in a selected state whereby it can comply with the power savings command.

### BACKGROUND OF THE INVENTION

1. Field of the Invention

This invention relates to power savings in networked computing devices and more particularly relates to sending a power saving command to a networked computing device to cause it to transition to a lower power state.

2. Description of the Related Art

Computing devices provide a myriad of functions to their users including word processing, spread sheets, database access and storage and accounting. For the most part, computing devices provide useful functionality for a limited period of the day. For example, personal computers generally go unused at night when the computer user is not around. In order to save energy and extend the life of computer parts, computer administrators and computer designers have created various devices and programs to reduce computer power consumption during idle times.

Complicated power management systems are now integrated parts of many computers from laptops to desktops. These power management systems save power by turning off video output, turning off hard drives, placing the computer in a sleep mode, or shutting down the computer entirely.

Before executing a power saving strategy, the system must first check the activity level of the computer. A computer must not shutdown while a user is typing at the keyboard. The system must balance its power saving goals with legitimate computer use. The system may track computer activity level to gauge when it would be appropriate to implement a power saving strategy. Computer activity may be monitored by measuring keyboard inactivity, screen image changes, hard disk activity, and CPU usage.

Despite efforts by many designers to create computer systems that conserve power, the computers themselves continue to use greater amounts of power. Screensavers themselves have become part of the problem. Screensavers perform complicated mathematical computations to render animated transformations of complicated graphical images. These activities may use CPU time, access the hard, and create changing video images. Though screensavers were originally designed to extend the life of computer screens, today they sometimes defeat power saving schemes by simulating an inappropriately high level of computer activity.

Computers that could be idle are consuming valuable resources. They consume power, generate heat, and wear out their hard drives, screens, and processors. Efforts have been made to reduce the waste created by idle computers. While some of these efforts have been successful and have reduced power consumption, the current efforts address the problem on a computer-by-computer basis. Screensavers and power saving programs are implemented on individual computers and must be managed one computer at a time. A computer administrator is forced to configure power management settings on each machine individually. Also, the computer user may defeat the administrator's policies by changing the power management settings on an individual computer.

What is needed are a method, apparatus, and system that can be controlled by a computer administrator to implement and carry out a computer administrator's power management policies in networked computing devices. Beneficially, such a process, apparatus, and system would allow a computer administrator to centrally manage and reduce overall power consumption, extend the life of computer parts, and better utilize network resources. Because an administrator could manage the system centrally, the amount of time to manage power consumption reduction would be greatly reduced.

### SUMMARY OF THE INVENTION

The present invention has been developed in response to the present state of the art, and in particular, in response to the problems and needs in the art that have not yet been fully solved by currently available power management systems, processes and techniques. Accordingly, the present invention has been developed to provide a process, apparatus, and system for implementing power management systems that overcome many or all of the above-discussed shortcomings in the art.

The apparatus for reducing power consumption in a computing device on a network is provided with a logic unit containing a plurality of modules configured to functionally execute the necessary steps of reducing power consumption according to predetermined policies. These modules in the described embodiments include an interface module, a determination module, a power saving module, a policy module, a configuration module, and a state module.

The interface module, in one embodiment, is configured to receive a power saving command from a remote site on a network. The determination module, in one embodiment, is configured to determine whether the client is in a selected state such that it can respond to the power saving command. The power saving module, in one embodiment, is configured to execute a selected power saving scheme. The policy module, in one embodiment, is configured to store policy information for use in determining which of the plurality of power saving schemes to execute. The state module, in one embodiment, is configured to determine the current state of the computing device which in turn is used by the power saving module in selecting the proper power saving scheme.

In certain embodiments, certain modules of the apparatus may configured and positioned in the BIOS of the computing device, as part of a network interface card attached to the computing device, in the main memory of the computing device as a stand alone program or as part of the operating system of the computing device.

A system of the present invention is also presented for reducing power consumption by computing devices in a network computing environment. The system, in one embodiment, includes a network, a server computing device which sends power saving commands to client computing devices. The server computing device may be configured to send power saving commands according to configurable policies and parameters. The client computing devices may be provisioned in a manner similar to those described above in regard to the apparatus. The system may further include other features of the modeling apparatus described above.

A method of the present invention is also presented for reducing power consumption in a network computing environment. The method in the disclosed embodiments substantially includes the steps necessary to carry out the functions presented above with respect to the operation of the described apparatus and system. In one embodiment, the method includes determining whether the computing device is in a state which allows it to comply with the command, and executing a particular power saving scheme. The method also may include storing policy information which can be used by the apparatus in determining its current state and in determining which power saving scheme to implement.

A storage medium having computer code is also presented and configured to execute a method of the present invention for reducing power in a network computing environment. The method which is embodied by computer code stored in a computer readable medium may follow substantially similar to the method already mentioned.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a computer system of the prior art.

FIG. 2 is a schematic block diagram illustrating one embodiment of a server suitable for implementing the invention;

FIG. 3 is a schematic block diagram illustrating one embodiment of a client in accordance with the invention;

FIG. 4 is one embodiment of a schematic block diagram of the principal software modules in a server in accordance with the present invention.

FIG. 5 is one embodiment of a schematic block diagram of the principal software modules in a client in accordance with the present invention.

FIG. 6 is a schematic flow chart illustrating one embodiment of a method of the present invention for controlling power savings.

FIG. 7 is a schematic flow chart illustrating one embodiment of a method of the present invention for power savings in a client.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

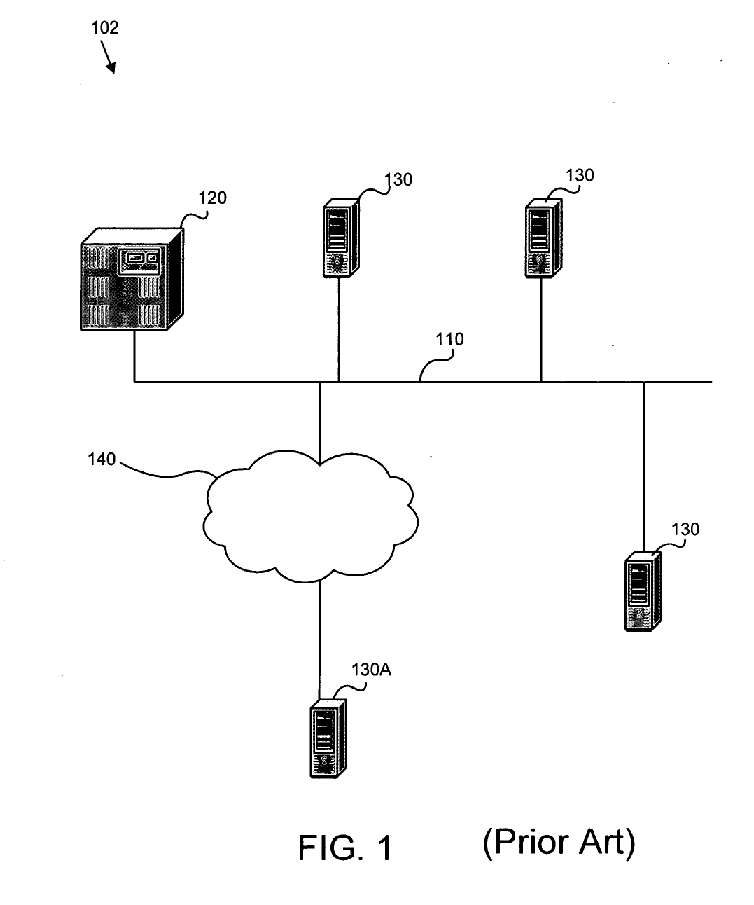

FIG. 1 depicts a system view of one embodiment of a system for transitioning networked computing devices to a lower power state. The illustrated power saving system 102 includes a network 110, a server computing device 120 and client computing devices 130. The client computing devices communicate with the server via the network. The network may at least partially include transmission over the Internet 140 to allow the connection of one or more remote client devices 130A. The network 110 may constitute any form of networking communication including Ethernet, Token Ring, leased lines, dial-up connections, FDDI, 802.11, bluetooth, infrared, USB, and so forth. The network 110 may also be made up of extranets, intranets, wide area networks (WANs), metropolitan networks (MANs), and local area networks (LANs).

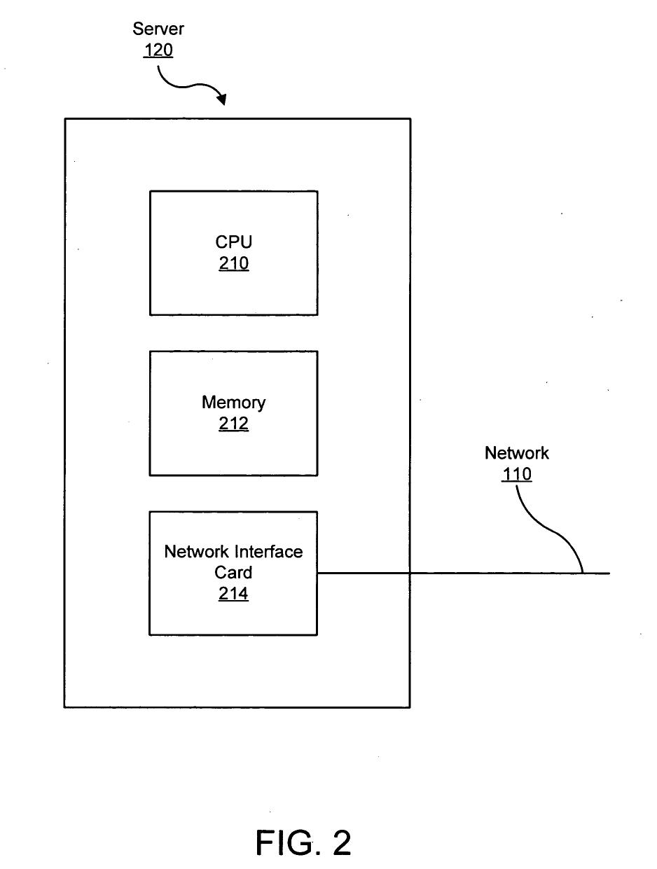

FIG. 2 depicts a representation of one embodiment of the server computing device 120 along with certain key components including a CPU 210, a memory 212, and a network interface card 214 connected to the network 110. The server computing device generally may have more components which are necessary to its operation and are well known to those skilled in the art. This embodiment illustrates the main hardware pieces of a selected embodiment of a server computing device.

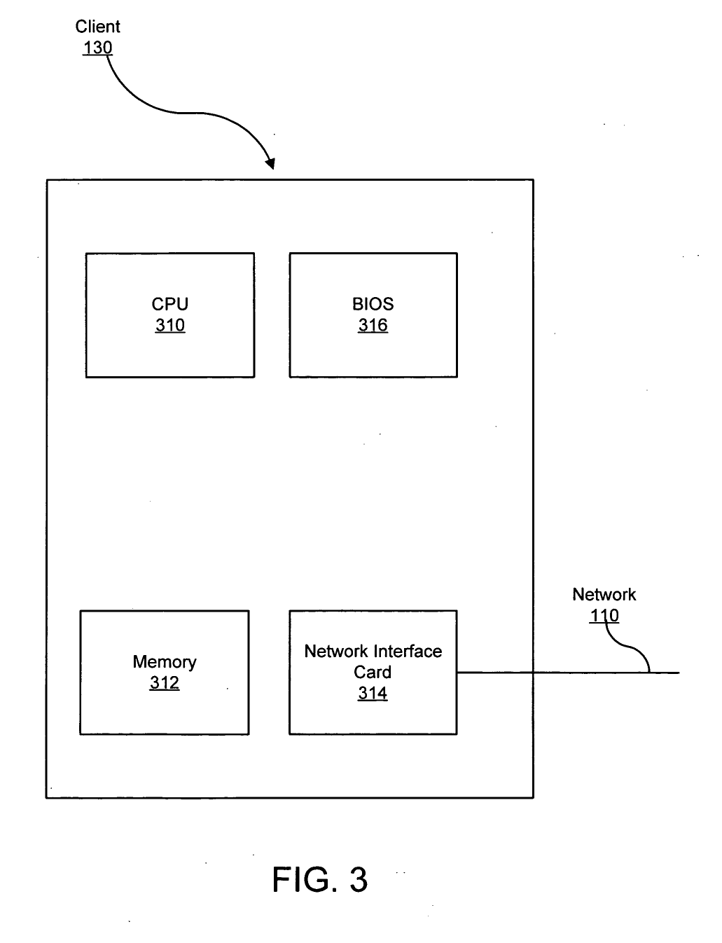

FIG. 3 depicts a representation of one embodiment of the client computing device 130. The client 130 may include a CPU 310, a Basic Input and Output System (BIOS) 316, a memory 312 and a network interface card 314 connected to the network 110. The client computing device generally may have more components which are necessary to its operation and are well known to those skilled in the art. This embodiment illustrates the main hardware pieces of a selected embodiment of the client computing device.

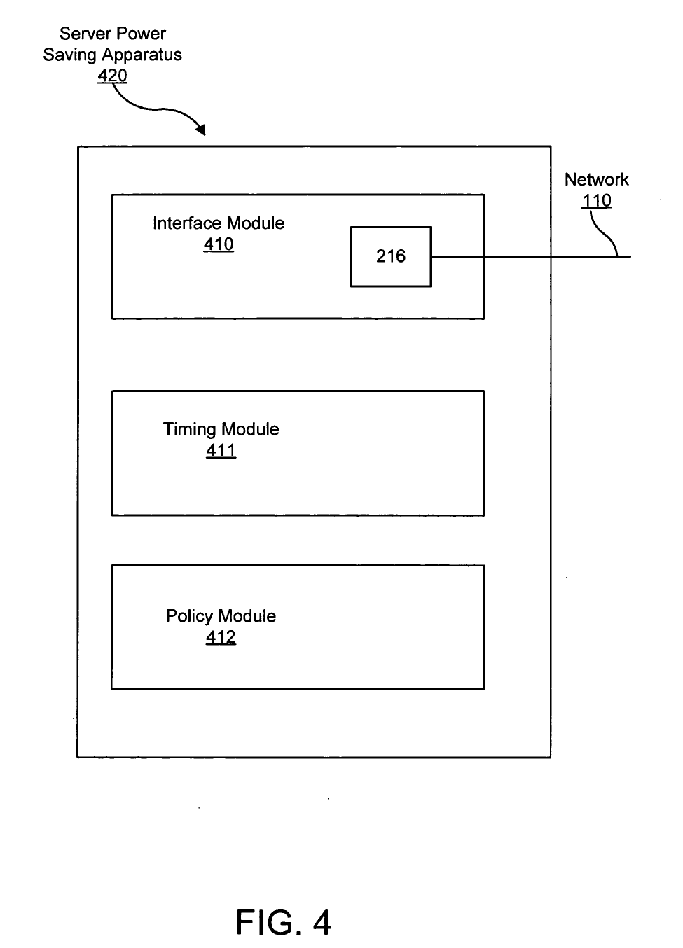

FIG. 4 depicts one embodiment of a server power saving apparatus 420 that in one embodiment is substantially similar to the server computing device 120 of FIGS. 1 and 2. While the server computing device 120 of FIGS. 1 and 2 illustrates the hardware of one embodiment of the server device, the server power saving apparatus 420 illustrates one embodiment of logical components of the server power saving apparatus which may be associated with the server computing device 120.

The illustrated server power saving apparatus 420 includes an interface module 410, a timing module 411, and optionally may also include a policy module 412. The interface module also preferably includes at least one network interface card 216 that is connected to the network 110. The interface module 410 is configured to transmit power saving commands to remote devices over the network 110. The interface module 410 may send power saving commands in broadcast fashion to all of the devices connected to network 110, or it may send power saving commands to individual devices based on an addressing system. The addressing system may be by way of example an IP addressing system.

The timing module 411, in one embodiment, may be used to select a time for transmitting the power saving command. The selected time may be predetermined or configured by an administrator. Additionally, the timing module 411 schedules when power saving commands may be sent to clients and initiates the transmission of power saving commands when the scheduled time arrives.

The policy module 412, in one embodiment, maybe used to store policies that control how and when to transmit power saving commands to remote devices. The policy information may include, by way of example, characteristics about individual remote devices such as IP address, default route to the device, predicted inactivity times, power priority level, and location. The policy information may also include general information to be applied to all devices or groups of devices.

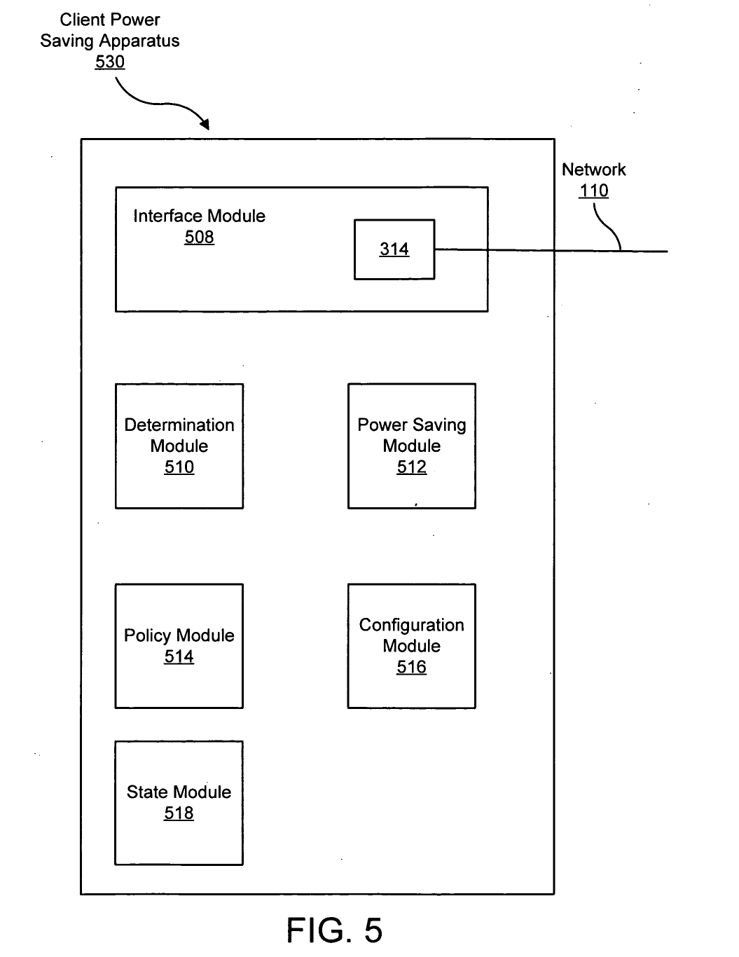

FIG. 5 depicts one embodiment of a client power saving apparatus 530 and may be substantially similar to the client computing device 130 of FIGS. 1 and 3. While the client computing device 130 of FIGS. 1 and 3 illustrates the hardware of one embodiment of the client device, the client power saving apparatus 530 illustrates one embodiment of the logical components of the client power saving apparatus that may be associated with the client computing device 130.

The illustrated client power saving apparatus 530 includes an interface module 508, a determination module 510, a power saving module 512 and optionally includes a policy module 514, a configuration module 516 and a state module 518. The interface module includes at least one network interface card 314 which is connected to the network 110 and receives power saving commands over the network 110 from a remote server device. Additionally, the interface module 508 may receive power saving commands that transmitted in broadcast fashion to all of the devices connected to network 110, or it may receive power saving commands that were sent directly to the client power saving apparatus 530 based on a selected addressing system. The addressing system may be by way of example an IP addressing system.

The network interface card 314 may be configured to detect power saving commands that are embedded in any commands that may be received over the network 110. Alternatively, the interface module 508 maybe configured to detect power saving commands in only those packets that the network interface card 314 passes to the interface module 508. Note that in one embodiment of the invention, the power saving command may be a predetermined sequence of bits that may occur in any packet. In this embodiment, the network interface 314 card may be configured to detect the predetermined sequence of bits, regardless of the packet type in which it occurs.

The network interface card 314 may be configured to then generate an interrupt such as a System Management Interrupt (SMI) to notify the interface module 508 that a power saving command has been received. In another embodiment, the power saving command may be a specific packet type which will be identified as a power saving command according to its packet type. Various means for packet creation, typing and detection exist and are known to those skilled in the art.

The power saving module 512 is configured to execute a selected power saving scheme. The power saving module 512 may execute any of a variety of actions to reduce power consumption, including taking no action, turning the computing device off, placing the computing device into a low power state, placing the CPU of the computing device in a low power state through clock throttling, passing a message to the operating system of the computing device that mimics pressing a keyboard key, making a call to the operating systems of the computing device and turning off video output from the computing device.

The power saving module may execute one or more of these actions, making calls to the BIOS of the computing device, setting architected registers, or calling the computer's operating system. The interface module may make standard calls to implement these schemes. Many computing devices have Advance Power Management (APM) code and Advanced Configuration and Power Interface (ACPI) implementations. The interface module may call directly to these standard interfaces, or it may implement its power saving schemes directly.

The determination module 510 is configured, in one embodiment, to determine whether the current state of the client power saving apparatus 530 is compatible with any of the power saving schemes that might be selected for execution by the power saving module 512. For example, a computer that is currently being used for word processing by a user may be in an inappropriate state for a shutdown power saving scheme. Additionally, it might be inappropriate to throttle the CPU of a computing device that is performing a remote backup. The determination module 510 considers such state information and determines whether it is appropriate to act according to the selected policy or policy terms.

The state module 518, in one embodiment, is configured to track the current state of the computing device. For example, the state module may track one or more of the following: time elapsed since a key on the keyboard has been pressed, time elapsed since the hard drive has been accessed, time elapsed since the video image has changed, time of day, priority level of the machine and whether the machine is likely to perform unattended night operations. This list is not meant to be exclusive, but is given by way of example to illustrate some of the parameters that may be tracked by the state module 518. The state information may be used by the determination module 510 as well as other parts of the apparatus to determine how and when to execute power saving schemes.

The policy module 514 is configured, in one embodiment, to store information for use in selecting which power saving scheme is appropriate. The policy module 514 may store parameters and thresholds for the information stored by the state module 518. For example, the policy information may store how many seconds must elapse without keyboard activity before the state module would report that the computing device is inactive. As another example, the policy module 514 may store that the computing device is an accounting database which should never be shutdown.

The configuration module 516 is configured, in one embodiment, to receive input from a user regarding criteria for selecting which power saving scheme to implement. As an example, in one embodiment, the configuration module would provide a range of keyboard inactivity from which the user could select to be used to determine when the computer is in an inactive state. The configuration module 516 may be implemented as part of the operating system or separate from the operating system.

The modules of the client power saving apparatus 530 may be stored in the BIOS 316 of the computing device, in the memory associated with the network interface card 314, in the memory 312, in other locations not herein described, or in a combination of these locations. The execution of the code of the apparatus 530 maybe executed on the CPU 310, on a processor of the network interface card 314, on a processor not shown, or on a combination of these processors.

For example, in one embodiment, the network interface card is configured to detect power saving commands by scanning for a predetermined sequence of bits in packets received from the network. The network interface card then generates an SMI interrupt which is handled by an interrupt handler stored in the BIOS of the computing device. The SMI handler may then interface with the operating system through an ACPI call. The ACPI call may access the determination module 510, the state module 518 and the power saving module 512, as integrated parts of the operating system. In the same embodiment, the configuration module 516 may be implemented as a configuration menu under a power management module integrated into the operating system, and the policy module 518 maybe a storage block used to save the operating system's power management configuration information.

In an alternative embodiment, all of the code associated with determination module 510, power saving module 512, policy module 514, configuration module 516 and state module 518 may be stored in the BIOS 316 to execute outside of the auspices of the operating system.

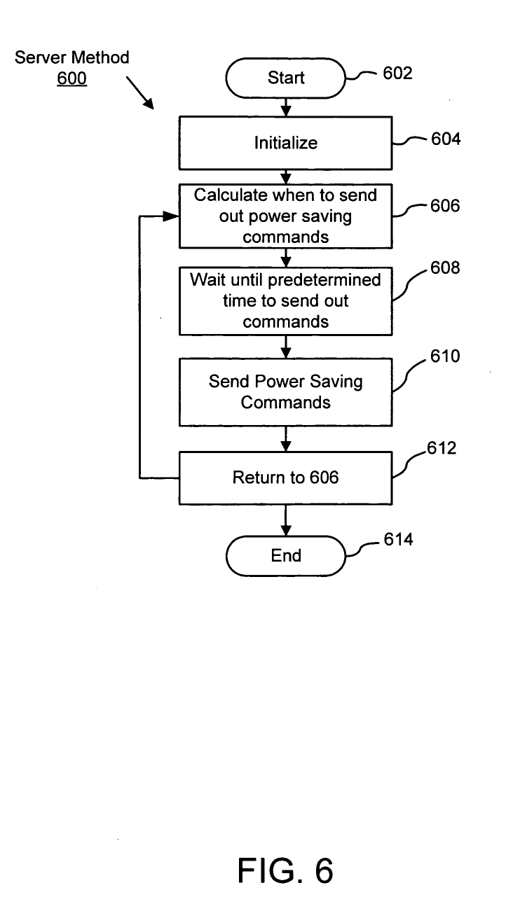

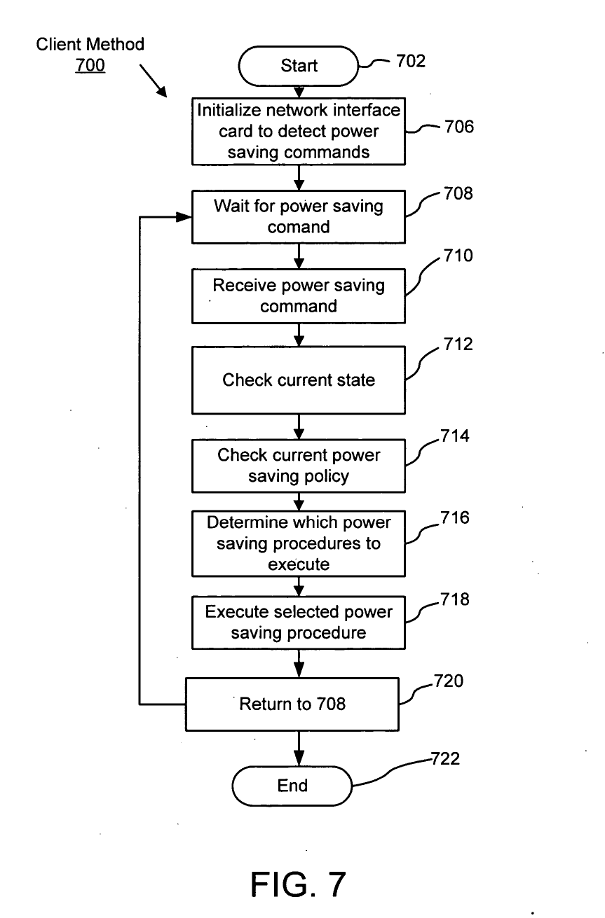

FIGS. 6 and 7 depict embodiments of power saving methods that may be conducted by the system and apparatus of FIGS. 1 through 5. Of course, the method may also be conducted independent thereof. FIG. 6 depicts one embodiment of a method that may be implemented on the server power saving apparatus 420. The server method 600 starts 602 by initializing 604 the server 420. The server 420 then calculates 606 when to send out the next power saving commands. It then waits 608 until the predetermined time has arrived. Once the predetermined time arrives, it sends 610 the power saving command to a selected group of remote computing devices. The remote computing devices may be a single computing device, a group of computing devices, or all computing devices that are configured to receive a broadcast power saving command on the network. After sending the power saving commands, the server 420 returns 612 to calculate 606 when to send out power saving commands again.

FIG. 7 depicts one embodiment of a method that may be implemented on the client power saving apparatus 530. The client method 700 starts 702 by initializing 706 the network interface card 314 to detect power saving commands. After initialization, the network interface card scans all incoming network traffic and waits 708 for a power saving command.

Upon receipt 710 of a power saving command, the network interface card may check 712 the current state of the client apparatus 530. It also checks 714 the current power saving policy. Based on the current state of the client and the current power saving policy, the client apparatus 530 then determines 716 which power saving procedures to execute. It then executes 718 the selected power saving procedure. Finally, the client apparatus returns 720 to waiting 708 for a power saving command.

This invention increases power savings for networked computing devices by providing a method, system and apparatus for transitioning networked devices to lower power states. It increases the efficiency of network administrators by providing a network-wide method of controlling power usage. Additionally, it allows a network administrator to customize the application of appropriate power saving schemes to appropriate devices at appropriate times.

1. An apparatus for power savings in a computing device communicating with a remote site over a network, the apparatus comprising:
an interface module configured to receive a power saving command from a remote site on a network;
a determination module configured to determine whether the client is in a selected state whereby it can comply with the power savings command; and
a power saving module configured to execute a selected power saving scheme responsive to a determination that the client is in a selected state whereby it can comply with the power saving command.

2. The apparatus of claim 1, wherein the power saving module is further configured to select from a plurality of power saving schemes, and further comprising a policy module configured to store policy information for use in determining which of the plurality of power saving schemes to execute.

3. The apparatus of claim 1, wherein the power saving module is configured to select from a plurality of power saving schemes, the apparatus further comprising a state module, the state module configured to determine the computing device's current state to be used by the power saving module in selecting from the plurality of power saving schemes.

4. The apparatus of claim 3, wherein the state module tracks at least one condition to determine the current state of the client, the condition selected from the group consisting of:
time elapsed since the keyboard has been pressed;
time elapsed since the hard drive has been accessed;
time elapsed since the video image has changed; and
the time of day.

5. The apparatus of claim 1, wherein the power saving module is configured to select from a plurality of power saving schemes, at least one of the plurality of power saving schemes selected from the group consisting of:
take no action;
turn the computing device off;
place the computing device into a low power state;
place the CPU of the computing device in a low power state through clock throttling;
pass a message to the operating system of the computing device that mimics the pressing of a keyboard key;
make a call to the operating system of the computing device; and
turn off video output from the computing device.

6. The apparatus of claim 1, wherein the power saving module is configured to select from a plurality of power saving schemes, and further comprising a configuration module configured to receive input from a user regarding criteria for selecting from the plurality of power saving schemes.

7. The apparatus of claim 1, wherein the interface module comprises a network interface card configured to generate a system management interrupt upon receipt of the power saving command from the network.

8. The apparatus of claim 7, wherein the determination module and the power saving module are stored in a BIOS of the computing device and are called as a result of the system management interrupt.

9. The apparatus of claim 7, wherein the determination module and the power saving module are part of the computer's operating system and are called as a result of the system management interrupt.

10. The apparatus of claim 9, wherein the computing device's operating system comprises an Advanced Configuration and Power Interface and wherein the interface module is configured to access the determination module and the power saving module via the Advanced Configuration and Power Interface.

11. A server for initiating power savings in a plurality of computing devices across a network, the server comprising:
an interface module configured to transmit a power saving command to a remote computing device across a network;
a timing module configured to select a time for transmitting the power saving command; and
the power saving command configured to be received by a remote computing device that is configured to receive the power saving command and selectively enter a power saving state.

12. The apparatus of claim 11 further comprising a policy module configured to store policy information for use in determining how and when to transmit power saving commands.

13. A system for power savings in a network computing environment, the system comprising:
a network;
a server computing device configured to send a power saving command over the network; and
a plurality of client computing devices configured to receive a power saving command over the network, wherein the client computing devices are configured to receive the power saving command and selectively enter a power saving state.

14. The system of claim 13, wherein each client computing device comprises:
an interface module configured to receive a power saving command over the network from the server computing device;
a determination module configured to determine whether the client computing device is in a selected state whereby it can comply with the power saving command; and
a power saving module configured to execute a selected power saving scheme responsive to a determination that the client is in a selected state whereby it can comply with the power savings command.

15. The system of claim 13, wherein the interface module of each client computing device comprises:
a network interface card configured to generate a system management interrupt upon receipt of the power saving command from the network.

16. The system of claim 13, wherein the power saving command is broadcast to all client computing devices simultaneously.

17. The system of claim 13, wherein the power saving command is sent to each client computing device one at a time.

18. The system of claim 17, wherein the power saving command is sent to each client computing device according to the IP address of each client computing device.

19. A method for power savings in a computing device communicating with a remote site over a network, the method comprising:
receiving a power saving command from a remote site on a network;
determining whether the computing device is in a selected state whereby it can comply with the power savings command; and
executing a selected power saving scheme responsive to a determination that the client is in a selected state whereby it can comply with the power saving command.

20. The method of claim 19 further comprising:
storing policy information which can be used by the apparatus in determining whether the computing device is in a selected state whereby it can comply with the power savings command and selecting said power saving scheme; and
providing said policy information to the apparatus.

21. The method of claim 19, further comprising generating a system management interrupt upon receipt of the power saving command.

22. The method of claim 19, wherein the steps of determining whether the computing device is in a selected state whereby it can comply with the power savings command and the step of executing a selected power saving scheme are executed from code stored in a BIOS of the computing device.

23. The method of claim 19, wherein the steps of determining whether the computing device is in a selected state whereby it can comply with the power savings command and the step of executing a selected power saving scheme are executed as a result of a call to the operating system's Advanced Configuration and Power Interface.

24. An apparatus for power savings in a computing device, the apparatus comprising:
means for receiving a power saving command from a remote site on a network;
means for determining whether the computing device is in a selected state whereby it can comply with the power savings command; and
means for executing a selected power saving scheme responsive to a determination that the client is in a selected state whereby it can comply with the power savings command.

25. The apparatus of claim 24 further comprising:
means for storing and providing policy information which can be used by the apparatus in determining state and selecting said power saving scheme; and
means for receiving configuration input to modify the functioning of the apparatus.

26. A computer readable storage medium comprising computer readable code configured to carry out a method for power savings in a computing device, the method comprising:
receiving a power saving command from a remote site on a network;
determining whether the computing device is in a selected state whereby it can comply with the power savings command; and
executing a selected power saving scheme responsive to a determination that the client is in a selected state whereby it can comply with the power savings command.

27. The computer readable storage medium of claim 26, wherein the selected power saving scheme is selected from a plurality of power saving schemes, the method for power savings further comprising storing policy information for use in determining which of the plurality of power saving schemes to select for execution.

28. The computer readable storage medium of claim 26, wherein the step of receiving a power saving command is performed by a network interface card.

29. The computer readable storage medium of claim 26, wherein the method for power savings further comprises generating a system management interrupt.

30. The computer readable storage medium of claim 24, wherein the method for power savings further comprises calling the computing device's BIOS to handle the steps of determining whether the computing device is in a selected state and executing a selected power saving scheme.

31. The computer readable storage medium of claim 24, wherein the method for power savings further comprises calling the computing device's Advanced Configuration and Power Interface to handle the steps of determining whether the computing device is in a selected state and executing a selected power saving scheme.
